(19) United States
(12) Patent Application Publication
(10) Pub. No.: US 2018/0218402 A1
(43) Pub. Date: Aug. 2, 2018

(54) Just In Time Online Advertising and Promotion System

(71) Applicant: Saied Saadat, North Chelmsford, MA (US)

(72) Inventor: Saied Saadat, North Chelmsford, MA (US)

(21) Appl. No.: 15/885,764

(22) Filed: Jan. 31, 2018

Related U.S. Application Data
(60) Provisional application No. 62/453,168, filed on Feb. 1, 2017.

(51) Int. Cl. G06Q 30/02

(52) U.S. Cl. CPC G06Q 30/0257; G06Q 30/0261; G06Q 30/0277; G06Q 30/0272

(57) ABSTRACT

This invention proposes a real time advertising and promotion apparatus that manages and distributes advertisement and promotion and marketing material to mobile, and in some cases stationary users based on their exact locations relative to where the advertised product and service is offered. The selection of ads are done with direct input from users. Each user creates his or her own selection criteria that are applied at run time to figure out the appropriate set of ads that offer products and services in which the user has expressly shown interest. Ads are delivered and presented to users directly through the system's interface, which offers a rich set of functions to the user that can be used to control what they receive and see, when and where. The system offers additional features that help users manage and use the ads that are presented. The apparatus also supports location and/or distance targeting for mobile vendors that do not have a fixed location and constantly or periodically move.

### BACKGROUND

Location based advertising has been one of the biggest and most important tools for online advertisers. Advertisers who offer products and services that suit certain geographical areas use location based advertising to target people who reside or are otherwise present in those areas. Advertising campaigns are usually set up to target users in areas that are fairly large. Often times, the targeted areas correspond to official boundaries, such as a district or a town. The exact location of users in those areas are not generally known or otherwise considered. Once the user is found to be within the targeted area, he or she is considered a target. If only the area, not the exact spot, where users are present is considered, the exact distance to the location of the spot where the advertised product or service is being offered cannot be used as part of the targeting criteria. Furthermore, such method is unable to target specific spots, locations or areas, such as a park, a shopping mall, a specific street block, or right in front of a store. This becomes especially difficult for areas with irregular shapes that do not conform to typically used geometrical shapes such as circles or rectangles.

Additionally, existing ad systems do not consider the location of the vendor or the provider of the product or service that is being advertised at the time the ad is served. The location of the vendor may be considered at the time that the ad campaign is set up but not when the ad is served. Even if the vendor's location is considered, it is assumed to be static. Mobile vendors, i.e. vendors that do not stay in one spot and move around, are not supported.

Furthermore, regardless of the location aspect, almost all direct advertising systems currently in place do not require the cooperations of their target users. That is to say, they target users whom they deem eligible whether or not those users like to be targeted. When a user watches a video on YouTube or other websites, he/she receives an advertisement before, during or after the video. Or, when the same user reads visits a news website to read an article, ads appear on the page they're visiting. The ads systems try their best to figure out what a user will potentially be interested in and tailor their ads to fit what they perceive to be the user's interest, but they do so without any direct input from users.

The triggering mechanism for ad serving is usually actions that users take on their device. Such action may include visiting a website, using a search engine to search for a restaurant, or using an application with integrated ad capability. That means, the user does something to trigger the serving of the ad. Pure geolocation triggering is not used. That is, no ad or promotion is served to users simply because they move from one location to another.

### BRIEF SUMMARY OF THE INVENTION

This system proposes an “advertising and promotion distribution system with precise geographical location targeting functionality” (referred to as “ad system” from hereon out), that combines users' and vendors' exact location and their preferences and interests to deliver promotional material to consumers at the exact time and location, to increase the efficacy of advertising campaigns and improve consumer satisfaction. The main operating mode of the system is voluntary, in that, consumers voluntarily disclose some information about whereabouts, their preferences in terms of goods and services they are interested in, as well as timing preferences and restrictions for receiving promotional materials. Furthermore, users of the system can control when and where to use the offered services and turn the them off when they do not wish to use them. Vendors, too, are able to specify some preferences and restrictions on consumers they like to target for advertising. The system matches preferences and restrictions from both sides, as well as location data and time, to make precise matches between consumers and advertisers. That way, consumers receive advertisements only for goods and services that they are interested in at the time and location they chose to receive them. This is not to say, however, that all said data are required for the system to work. The system can operate and deliver ads with any subset of the data available to it. If a particular data item that causes some restrictions or limitation is not available or not set, the effect of which is the same as being set to “unlimited” or unrestricted”.

The following is a non-exhaustive list of the proposed system's main characteristics.
a) Taking direct input from users and using it in determining what products and services they are interested in and should be advertised with. Such input is completely under user's control and may be changed and updated at any time. Users are enabled to tie their interests to location and time, which allows them to receive advertisement for different products and services at different days, times and locations.
b) Ability for the user to turn the service on or off at any time or location.
c) Precise geo-location targeting of users, which allows for targeting of users in very specific areas, locations or spots, such as a shopping mall, a park, a street block, or exactly in front of a store. Support for areas with irregular shapes that do not conform to typical geometrical shapes like circles and rectangles are included.
d) Dimensional exact distance targeting, which allows targeting of users based on their exact distance in specific directions from a reference location. This allows the target area to be limited to specific directions or areas, in oppose to radial distance, e.g. limiting the targeted area 80 yards to the left and 20 yards to the right of the store on the street, in oppose to a 50-yard radius centered on the store's location.
e) Methods for supporting location and distance targeting of users for mobile advertisers or vendors, where the location of the vendor and/or advertised product or service changes over time, in a predictable or unpredictable fashion.
f) Automatic triggering of serving of ads based on changes in user's location, without requiring any additional actions on the part of the.
g) Methods for allowing users to further restrict the ads they receive based on secondary criteria such as vendor's rating, product's rating, type and amount of discounts offered in the ad and other criteria.
h) Performance based promotion management that allows advertisers to manage their promotions based on the usage numbers instead of distribution numbers; e.g.: serve coupons until “1000 used/redeemed”, in oppose to “100,000 distributed”.
i) Blind serving of ads and promotions when users lose or turn off the GPS function of their device; and offline serving of ads and promotions when they lose connection to, or disconnect from the internet.
j) Methods for serving ads and promotions indirectly, through other resident applications on users' devices, i.e. operating as a client side ad serving engine.

### SUMMARY OF SOME EMBODIMENTS

The followings are some embodiments that are presented to demonstrate and highlight the main functionality and features of the system and how they work for different usage scenarios.

According to one embodiment, a mobile user, that is, a user with a mobile devices, such as a smart phone, a tablet, car navigation system, or any other mobile device that is capable of connecting to internet and/or receiving GPS signals (referred to as “mobile device” from hereon out), sets his/her preferences in terms of categories of products and services in which he/she is interested and wishes to receive promotional material. By doing so, the user restrict the ads to only those that satisfy the set restrictions. For instance, when the user specifies “Sports” and “Food” as his interests, he will receive only ads that are related to either Sports or Food and nothing else.

According to another embodiment, the mobile user sets location criteria for advertisement that he/she receives. Location criteria may be specified in different ways relative to the location where the advertised product or service is offered, such as distance or a physical area (e.g. town or neighborhood). As the user moves about, only ads whose location satisfy the set criteria are delivered and shown. Eligibility of ads can change after they are delivered to the user's mobile device, in which case they are removed from the primary ad list to a secondary ad list where they are not shown to the user proactively but still can be accessed by the user if he/she wishes to see them.

According to another embodiment, the user can set timing criteria for the advertisements that he/she wishes to receive. Different components of time and date may be used in any combination when setting timing criteria, e.g. day of the week, time of day, weekdays or weekends, etc. Timing criteria may be combined with any other criteria in any non-conflicting way.

According to another embodiment, the user can set secondary criteria on products or services, and vendors in any combination. Restrictions could be on different nature such as the type, brand name, or ratings. For instance, the user may specify “Italian” for the “type” of food, “Nike” for “brand” of apparel, or “4 or more starts” for “rating” of the product.

According to another embodiment, the user can block/unblock or promote/demote a specific product or service, or a vendor. By blocking a product, service or a vendor, the system stops sending corresponding ads to the user. Restrictions or promotions may be applied to different attributes of the product and service, or the vendor. For instance, blocking the “cheese cake factory” brand restaurant, blocking “sporting goods”, or promoting “car service”.

According to another embodiment, the user sets criteria on the type of promotion offered in the advertisement, for instance, “free trial”, “at least 20% off” and “free stuff with purchase”.

According to another embodiment, the user is able to review rating and read reviews of the advertised products and services. The user can also post rating and write reviews for the products and services he/she used and their vendors, all within the application. Rating may also be integrated with one or more external rating systems which are seamlessly accessed from within this system.

According to another embodiment, the vendor can set location criteria for users they want to target for advertising. Setting location criteria restricts ads to users that satisfy them. Location criteria can be set in different manner such as distance, e.g. “within a one mile radius”, absolute area, e.g. “in Hyde Park neighborhood of Boston”, or “100 yards on the right and 50 yards on the left side on the same street”.

According to another embodiment, the vendor can setup a coupon campaign whose completion condition is based on coupon redeemed. This way, an ad campaign runs until the target number of coupons are redeemed for the related products or services or it's manually terminated.

According to another embodiment, the system can temporarily block or permanently drop the vendor from the system for reasons such as low rating or complaints. A blocked or dropped vendor would not be able to advertise through the system until it's unblocked.

According to another embodiment, the system works with other client side application such as maps, navigation and games in a reduced capacity to deliver ads to the user on his/her device. The available functionality will be determined partly by the capability with host application that the user interacts with. For instance, rating feature of the product may not be available to the user in such scenarios due to restriction of the host application with which user is interacting.

According to another embodiment, the user might use the system to perform free search of businesses, products and services, and vendors. In such capacity, the location criteria are directly set and manipulated by the user instead of extracted automatically through via the GPS function of the user's mobile device. This functionality is useful when user is planning ahead and wants to see what kind of services and products will be available to him/her, or is simply shopping for a product or service with location not being a factor.

According to another embodiment, ads are served to the user when the user loses connectivity to the service due to any reason. A cache of ads on the user's device can be used for serving ads while being disconnected from the service. The program running on the user's device can serve the ads and collected user's feedback and other related data and store it locally and send them back to the server when its connection is restored.

According to another embodiment, the system applies location criteria, including distance restrictions to ad campaigns for mobile vendors. A vendor that is mobile, i.e. does not have a set location, has an area of serviceability that is dynamic and changing depending on its own location. Therefore, drawing static boundaries for advertising to its potential customers would be of little use; because the actual service boundaries move based on the movement of the vendor. A mobile auto mechanic, an ice cream truck, and a taxi driver are examples of such. When they move around, they want to target people who are or going to be near them. This invention addresses that problem by allowing vendors to specify target areas that are relative to their own location at the time ads are being served. It does so by evaluating the campaign's location criteria dynamically based on the current location of the user and the vendor alike. The distance of the user from the vendor is calculated in real time to make the determination as to whether or not the user is within the specified distance from the vendor. There may be other criteria beside distance that mobile vendors might want to use. Regardless of the criterion, because the evaluation is done in real time and the locations of both the vendor and the user are considered, the desired results are achieved. Mobile vendors can use all criteria that stationary vendors use as well. They can, for instance, specify a static area as their target, regardless of their own location.

In another embodiment, the system caters to users who use stationary devices which may not have any GPS capability. Stationary devices include desktop, laptops, TVs and others. In such cases, the user can specify a target location on the system's client application that is running on their device and get advertisements that satisfy the geographical constraints as well as other constraints that the user has specified.

In another embodiment, the system is used in a disconnected mode, by a user who may or may not be known to the system. In such mode, the user uses the system's client application to setup location and other criteria that he/she wishes and performs a search. The search results would be the same as if the user were using the system in the normal operating mode. All advertisements that match the set criteria are shown to the user inside the application, where he/she can view, browse and search through them. This operating mode may be useful in a number of situations including planing ahead for future travels, looking up ads for someone who does not have an account with the system, or similar situations.

In another embodiment, the system provides additional assistance to the user who is interested in particular product or service by providing additional information on the advertised product or service, or the vendor that offers it. Navigation assistance may be provided to the user as well. Voice driven commands are used to make it easier for users who are either unable to use the interactive screen or prefer voice interaction with the system, for instance, in case of a customer who's driving.

### BRIEF DESCRIPTION OF THE DRAWINGS

FIG. 1 is a diagram that shows the main components and actors of the system.

FIG. 2 shows the major components of an Ad Client Application.

FIG. 3 depicts the major components of an Ad Server system.

### DETAIL DESCRIPTION OF THE INVENTION

The general working principle of the proposed solution is to put consumers in charge when deciding what kind of advertisements they receive, where and when. To achieve that, variety of settings, configurations and controls are made available to them to create and customize an environment that best suits they needs and wishes. All the settings and controls may be put in one of the following four categories: location, time, interests, and product. The ability to combine the criteria from all of these category in a precise and accurate manner is the main distinguishing feature of this invention. By setting the criteria in each of the categories, users can create an ad delivery environment that is customized to their needs and interests. Due to that, ads that are delivered via that environment are far more likely to be received, liked and used by users. This system takes the guess work out of figuring out what users might be interested in, which is the case for almost all the existing ad systems, and put the responsibility on consumers to tell the system what they're interested in, what products, services and vendors they would like to hear about and what they don't want to hear about. Consumers are not the sole beneficiary of this system. Vendors and advertisers benefit from it as well. In this system, ads are much more likely to be received favorably by consumers since they control the environment. That increases the efficiency of ad campaigns and higher efficiency in turn means lower cost.

Exact targeting of users is especially useful for businesses that rely on local customers. Local customers in this context means customers who are, or soon going to be in close proximity to the product or service vendor. For instance, a pizza shop, might have a lot of success with an ad campaign that targets people who are interested in food/pizza and are within 200 yards on the shop, which is exactly what this system is designed to do. Such campaign can be even more precise by targeting people who like food/pizza and just happen to be on the same street as the shop and within a 200 yard distance.

For many consumers, products, services and vendors, timing of the ad is crucially important. Delivering an ad at the right time can affect the effectiveness of the ad in a very significant way. Take the aforementioned pizza shop for example. A discount coupon that is delivered to a person who is in close proximity to the shop is much more likely to be used if it's received around lunch time, compared to 4 PM. An ad for movies is likely to be favorably received by a consumer on Friday, or Saturday night, compared to Tuesday morning.

Interest categories set by consumers eliminate the need for the system to try to figure out and guess what kind of things a particular user is interested in. By setting up their interests, consumers tell the system what they are and what they are not interested in. That significantly reduces the amount of unwanted ads that are sent to consumers, thus, increasing customer satisfaction and reducing cost.

The product category of settings comprises all criteria that have to do with product, vendor and ad characteristics and quality. Things like product and vendor star rating, brand name, ad and promotion type, and amount of offered discount fall under this category, which can be used by consumers to further control the kind of ads they receive.

Using all or subset of these categories, consumers can create a very specific ad consuming campaign that is tailored to their specific needs. This has the effect of enabling advertisers to have one customized campaign per consumer.

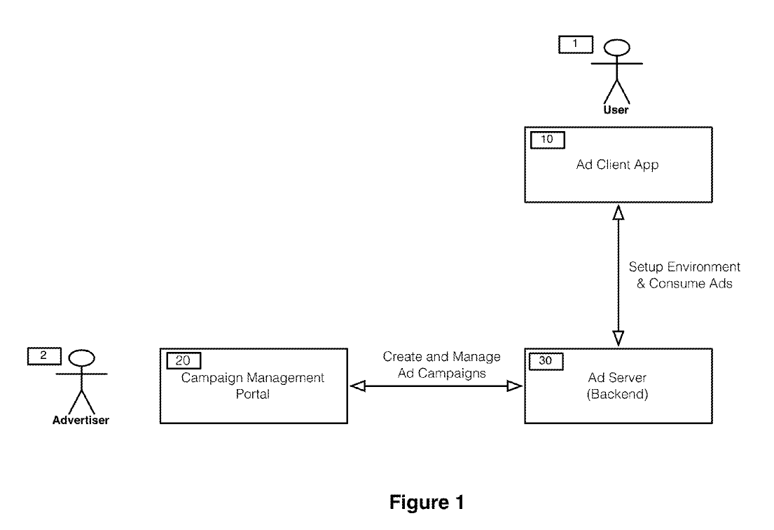

FIG. 1 shows the major components and actors of the physical system that implements and provides all required functionality. The entire system comprises three major components: Ad Client Application (10), Ad Campaign Management Portal (20) and System Backend (30). The figure also shows two external actors of the system, the user (1), which is the consumer of ads and the advertiser (2). Ad client application (10) is what users or consumers use to interact with the system, including setting up their environment, receiving and consuming ads and sending queries and receiving back responses. Campaign Management Portal (20) is what advertisers use to interact with the system and setup, monitor, and manage their advertising campaigns. The portal can have different forms and may run on different types of devices. For example, it can be a browser based or stand alone application, a mobile application, or even an Interactive Voice Response (IVR) system. The Ad Server (30) is the backend of the system where everything comes together, campaigns are executed, ads are delivered, reports are generated, and everything else that needs to happen to setup and execute ad campaigns, and deliver ads to consumers.

Advertisers or their agent use the campaign management portal to set up their ad campaigns. Through the portal, they specify all the properties of their campaigns, including start time, preferred target demographic, completion criteria, distance restrictions and any other attributes allowed and supported by the system. They also upload all campaign materials such as creatives for the ads. The portal is used to deploy the campaign as well, and once the campaign is deployed and its start time arrives, the system starts executing it. On the other side of the system, users create their own “ad consumption campaigns” through the ad client (10). Users' and advertisers' ad campaigns come together in ad server (30) and matches are made at run time between advertisers' and users' criteria and matching ads are delivered to the users by the ad server (30) via the ad client (10).

The client application (10) is the primary point of interaction with the system for the end user. It interacts with the user in two different ways. It allows the user to set up and change his or her preferences, which may include: enabling or disabling services, pausing or resuming services, setting up preferences and interests, etc. The app is also responsible for interacting with the system, i.e. the ad serving engine, to fetch, receive or cache ads or promotions and display them to the user. In this process, the application also transmits the relevant data back to the system. The transmitted data may include the location data, ad or promotion performance data, usage data and others. The application may also work in blind or offline mode. The blind mode disables the location aspect of the application by stopping the transmission of location information to the back end of the system. The blind mode allows the ads and promotions to be served even when the client's location is not known, when possible.

The client app (10) performs its interactions with the ad server (30) seamlessly without the user having to do anything, and keeps the user's ad content on his/her device up to date. There are several different triggers for the client app to perform an update. The main ones are changes in location and time. As the user moves about, and as the time passes, new sets of ads may become eligible for viewing by the user and some of the existing ads on the user's view may become ineligible. The client handles all the updates on the background and keeps the user's content up to date at all times. Because the client keeps a cache of ads on its side, it does not have to contact the server constantly to keep the user's view up to date. The client tries to handles all the changes locally on the client side and only calls the server when it requires additional ads or information that it does not have. As the user moves about and/or as time passes, the client application keeps the list of ads that is visible to the user accurate by removing ads that no longer match user's criteria from the list and add newly eligible one to it.

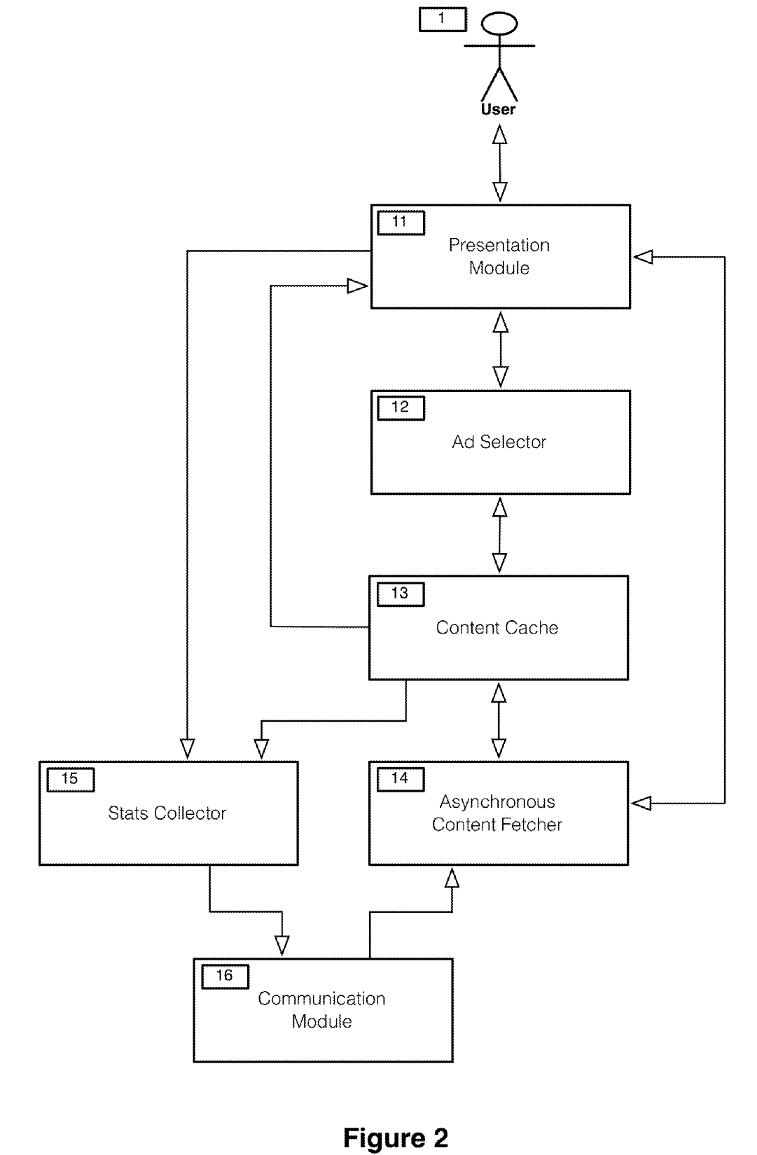

FIG. 2 shows the major components that make up the client application (10). The figure shows only one way in which the component can be designed. There may be many different or similar ways to achieve the same results. The functionality provided by these modules collectively handle all client related operations from environment settings and configuration, to presenting ads, and collecting and submitting the relevant data to the ad server (30). All users' explicit interactions with the system is performed through the presentation module (11). The presentation module provides a graphical interface that provides two main sets of functions: setting and configuration, and ad presentation and consumption. Setting and configuration data is collected and sent back to the ad server (30) to be stored in the system and used in ad selection operations. Ad presentation and consumptions function of the presentation module takes care of presenting the ads that have been selected for the user at any time.

Ad selector module (12) is responsible for selecting the right ads from the cache of ads available on the user's device based on the current time and location of the user. At any point in time the ad cache may contain ads that do not satisfy all ad serving criteria at the current time and location. The filtering of ads is done by the ad selector so that only appropriate ads are shown to the user. Ad selector (12) might also notify the cache if any content is missing so it can fetch it from the appropriate source.

Content Cache (13) receives content from the asynchronous content fetcher (14) and serves the up to the ad selector (12) and the presentation module (11). The presentation module (11) can ask for detail content of a specific as directly from the cache without going through the ad selector (12). Ad headers or records are fetched by the ad selector (12) from the cache before they are served to the presentation module (11). The content cache (13) module is in charge of making decisions about which content to keep and which content to purge based on the current and anticipated circumstance. This task is important due to limited resources available to the application on the user's device. The content cache may decide to fetch ads for a larger area that is currently needed by the ad selector (12) based on the user's movement. This is to reduce the number of time that it needs to send a request to the ad server to fetch more ads and speed up the process of serving the user with correct ads.

Asynchronous Content Fetcher (14) is a module that fetches content from the backend, asynchronously. This module sends submits to the backend the current location of the user when it significantly changed and receives back a new set of ads that have already become, or are anticipated to soon become eligible for serving based on the current location or the user and time. The ads that are sent back to the client app by the backend are put in the cache where they are served to the ad selector (12) at the appropriate time. In some cases, this module might have to respond to requests and fetch some content synchronously to minimize the latency experienced by the user.

All significant event on the client side are collected and sent to the backend system by the Stat Collector module (15) for analysis. Stat collector (15) collects all those events and submits them in batches. If the device has no connectivity, the stat collector stores data it's collected locally on the device and submits them when the connectivity is restored. The data submitted are collected on the backend from all clients, combined and analyzed for variety of reasons including improving ad serving processes.

Communication Module (16) handles all communications from the client app to ad server (30).

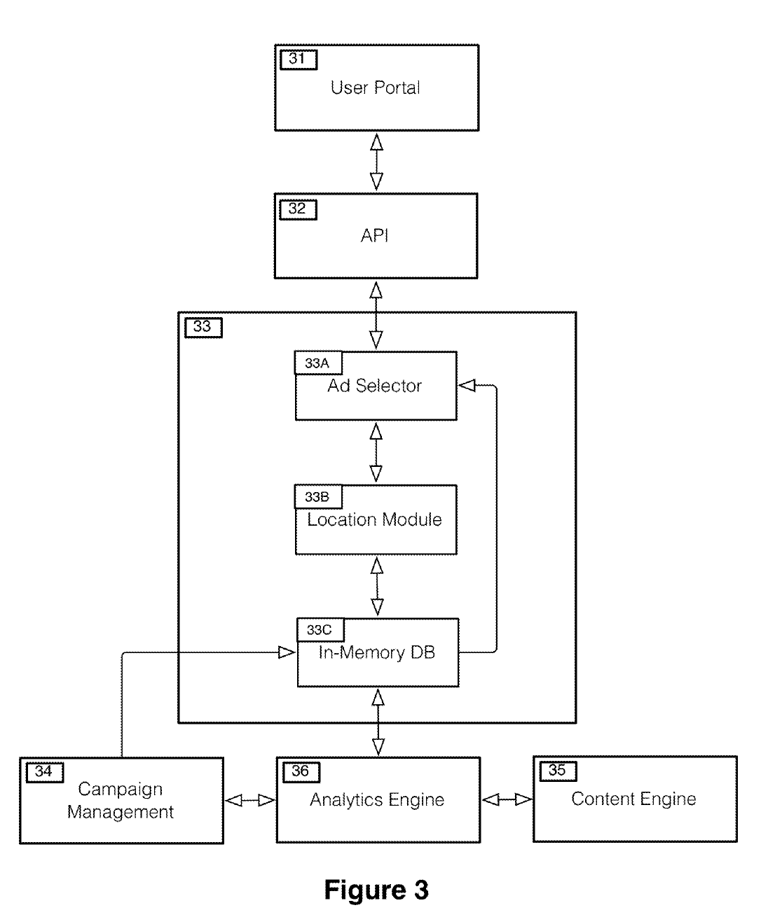

FIG. 3 shows a set of modules that make up the Ad Server (30) component. The figure only shows one way that this component can be implements and there may be other ways to achieve the desired functionality, which may have different set of modules. In the design shown in the figure, the Ad Server component (30) consists of six major sub-components or modules, which together perform all tasks necessary to run the system. User portal (31) is what the user application talks to when communicating with the ad server (30). Sending and receiving any kind of data and/or messages is done through the portal. The API module (32) is the interface between the portal and the backend. This is to provide consistent access to the services that the ad server (30) provides to all its clients regardless of how they access the system. Ad serving engine (33) is the component that is responsible for responding to clients' requests for ads by selecting, preparing and submitting the best set of ads that satisfy all the requirements and criteria set by users and advertiser. Campaign Management (34) handles all things related to setting up, executing and managing ad campaigns. This component is mainly responsible for responding to queries from the advertiser portal. Content Engine (35) is responsible for managing and making available to other components all contents including campaign records and creatives, statistics, reports and any other persisted content, as well as ensuring the safe and secure storage of all data. Analytics engine (36) is an auxiliary component that is used for analyzing all relevant data and producing intelligence that can be used to improve the system as a whole, including user experience and internal and external processes that might lead to cost saving or increasing campaign efficiency.

The Ad Server Engine (33) contains three module of its own, in this design. Ad Selector (33A) makes all ad selections at the request of the client based on all relevant criteria, such as the user's location, current time, user preferences and restrictions, campaign restrictions and statistics, ad viewing data, and input from the analytics engine. Location module (33B) handles all calculations related to geographical location. Location and geo-coordinate related calculations can be complicated and computationally intensive. For that reason, a dedicated module is assigned to handle all related operations. In-memory database (33C) is a module that provides fast read and write access to sensitive data for operations that are time sensitive, especially the ones that affect users' experience.

1. A direct advertising apparatus comprising an independent, standalone and interactive application that takes direct input from its users and delivers advertisement and promotional material chosen based on the input from the user.

2. The apparatus of claim 1, further comprising of methods enabling users to restrict the advertisement they receive by time of day, day of week, and any combination thereof.

3. The apparatus of claim 1, further comprising of methods allowing users to restrict or promote any number of categories of products or services in their entirety, or specific subset within them using product or service types or brand, or by names.

4. The apparatus of claim 1, further comprising of methods allowing users to block or unblock, restrict or promote any number vendors from the advertisements they receive.

5. The apparatus of claim 1, further comprising of methods allowing users to restrict the advertisement they receive based on product and/or vendor rating.

6. The apparatus of claim 1, further comprising of methods allowing users to restrict the advertisement they receive based on the type and amount of promotions and discount the advertisement offers.

7. The apparatus of claim 1, comprising of methods which allow users to promote or restrict advertisements they receive based on any combination of vendor name, product category, brand or name, vendor and product rating, and promotion and discount type and amount.

8. The apparatus of claim 1, comprising of methods which allow users to read ratings and reviews for the advertised product and record rating and write reviews all within the apparatus.

9. A direct advertising apparatus comprising of receiving the exact location of its target users and limiting the advertisements to such users to product and services that are offered within the user specified distances to any specific directions or any specific areas that do or do not conform to a typical geometrical shapes.

10. A direct advertising apparatus comprising of methods that allow user or vendor defined distance or area restrictions to be enforced on mobile vendors who do not have a fixed location and change location continuously or periodically.
